(19) United States
(12) Patent Application Publication
(10) Pub. No.: US 2009/0307017 A1
(43) Pub. Date: Dec. 10, 2009

(54) APPAREL AND TEXTILE INSURANCE SYSTEM AND METHOD

(76) Inventor: John Mahdessian, Long Island City, NY (US)

Correspondence Address: OSTROLENK FABER GERB & SOFFEN, 1180 AVENUE OF THE AMERICAS, NEW YORK, NY, 100368403, US

(21) Appl. No.: 12/481,492

(22) Filed: Jun. 9, 2009

Related U.S. Application Data
(60) Provisional application No. 61/059,986, filed on Jun. 9, 2008.

(51) Int. Cl. G06Q 40/00; D06B 23/00; G06F 17/00

(52) U.S. Cl. 705/4; 700/225; 707/104.1; 707/E17.001

(57) ABSTRACT

In an embodiment, a system and method is provided for a processor to manage an apparel and textile item insurance policy. At least one database stored on processor enabled media includes electronic apparel information and electronic policy information. The electronic apparel information represents at least one apparel or textile item, and the electronic policy information represents at least one insurance policy respectively associated with the at least one apparel or textile item. A communication device that is operatively connected to one or more processors receives first electronic apparel information from a first user computing device operated by a first user. The first electronic apparel information represents a particular apparel or textile item. The one or more processors retrieves from the database(s) electronic policy information representing a policy relating to the apparel or the textile item, and the processor(s) assign the policy to the apparel or textile item. Electronic claim information is received from the first computing device or a second user computing device. The electronic claim information represents a claim on the policy for the apparel or textile item. The one or more processors determines whether the policy for the apparel or textile item covers the claim. If the policy covers the claim, then the one or more processors transmits an electronic authorization notification. If the policy does not cover the claim, then the one or more processors transmits an electronic denial notification.

### CROSS-REFERENCE TO RELATED APPLICATION

This application is based on and claims priority to U.S. Provisional Application Ser. No. 61/059,986, filed on Jun. 9, 2008 and entitled APPAREL AND TEXTILE INSURANCE SYSTEM AND METHOD, the entire contents of which are hereby incorporated by reference.

### BACKGROUND

1. Field

The present invention relates, generally, data processing, and, more particularly, to managing insurance of apparel and textile items.

2. Description of the Related Art

Accidents often occur that result in the staining or soiling of a person's apparel or clothing. For example, a glass of wine spills on a woman's formal gown, or a person slips in the mud and soils his suit, or a child spills something on an expensive couch. No matter how careful one is, accidents invariably happen. Unfortunately, accidents of this nature can spoil an otherwise turn an important event or day into a nightmare.

Unfortunately, an apparel or textile item that is stained and not treated properly in a timely way often results in a ruined item. If a gown or couch is timely treated, however, the stain may be removed and the garment or item salvaged. If a person does not act within a period of time, it may be too late to save the item. For example, the longer a stain remains untreated, oxidation may occur which causes the stain to set. In particular, when a stain is exposed to the air for an extended period of time, the composition of the stain changes, which creates an inability to safely and effectively remove the stain. Therefore, the longer a stain remains untreated properly, the likelihood that the stain cannot be safely and effectively removed increases. It is, unfortunately, often the case that people procrastinate, including to tend to spills on apparel and textile items.

The threat of an accident may serve as an impediment and prevent someone from purchasing an expensive item or apparel. For example, a person who is considering purchasing a $30,000.00 gown decides against doing so due to the risk of some unanticipated accident that could ruin the gown.

Consumers at one time or another have experienced the disappointment of a ruined or damaged garment, even though the consumers followed the simple instruction “Professionally Dry Clean Only.” This occurs due to the fact that a majority of “dry cleaners” in this country are not able to properly clean garments, which require unconventional cleaning, processing or special attention to certain factors in cleaning and finish. These cleaners either lack understanding, correct techniques, specialized workmen or proper machinery to treat anything but the most basic fabrics and garment construction. Many textiles cannot tolerate excessive heat, moisture or mechanical action and are, therefore, damaged during standard cleaning processes.

Care labeling for apparel and textiles is a mandated prerequisite by the Federal Trade Commission. Each care label is required to give specific care instructions to govern and safeguard that particular garment. These instructions should give the appropriate advice to consumers as well as the cleaner who would be responsible for following the instructions precisely.

Even though care labeling occurs, prior art care labeling unfortunately is often insufficient to identify particular treatments for a wide variety of textiles and apparel, including but not limited to home furnishings and clothing.

Owners of expensive apparel and/or home textile items (e.g., couches, drapes, silk works, or the like) that are permanently soiled or otherwise ruined as a result of an accident may try to recoup losses by submitting insurance claims under their home insurance policies. While the owners may recover at least some of their loss under their home insurance policy, they may experience high premiums and/or an expensive deductible for submitting the claims.

### SUMMARY

Accordingly and in an embodiment, a system and method is provided for a processor to manage an apparel and textile item insurance policy. At least one database stored on processor enabled media includes electronic apparel information and electronic policy information. The electronic apparel information represents at least one apparel or textile item, and the electronic policy information represents at least one insurance policy respectively associated with the at least one apparel or textile item. A communication device that is operatively connected to one or more processors receive first electronic apparel information from a first user computing device operated by a first user. The first electronic apparel information represents a particular apparel or textile item. The one or more processors retrieve from the database(s) electronic policy information representing a policy relating to the apparel or the textile item, and the processor(s) assign the policy to the apparel or textile item. Electronic claim information is received from the first computing device or a second user computing device. The electronic claim information represents a claim on the policy for the apparel or textile item. The one or more processors determine whether the policy for the apparel or textile item covers the claim. If the policy covers the claim, then the one or more processors transmit an electronic authorization notification. If the policy does not cover the claim, then the one or more processors transmit an electronic denial notification.

Other and embodiments are provided, as well. For example, the policy may require that the apparel or textile item be maintained in accordance with custom care program. In one embodiment, a detailed and custom care label is provided that identifies the rules associated with the custom care program.

### BRIEF DESCRIPTION OF THE DRAWING(S)

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement in an embodiment;

FIG. 2 illustrates the functional elements of user workstation and/or information processor in accordance with an embodiment; and

FIGS. 3A and 3B illustrate a custom care label provided in connection with the teachings herein.

### DESCRIPTION OF EMBODIMENTS

In accordance with embodiments, one or more insurance policies are offered for sale and managed that protect an apparel or textile item against damage from, for example, accidental soiling. By insuring against accidental soiling, policy owners can realize significant cost savings, such as associated with damaged clothing. The costs associated with having a soiled suit or the like restored or reimbursed under the terms of the insurance policy are significantly less than costs associated with replacement.

Various features and alternative embodiments are provided in connection with the insurance policies in accordance with the teachings herein. In one embodiment, the insurance policy covers emergency cleaning services, and entitles the policyholder to cleaning services within a short period of time, for example, within two hours. Of course, one skilled in the art will recognize that other time periods may be defined in accordance with various embodiments. In an embodiment, complimentary shipper boxes are sent to customers as soon as claims are initiated. In another embodiment, the insurance policy guarantees that apparel will be treated in a matter of hours following an accident. In this alternative embodiment, a person is insured against the possibility of having to forego a formal engagement or event due to an accidental spill or the like.

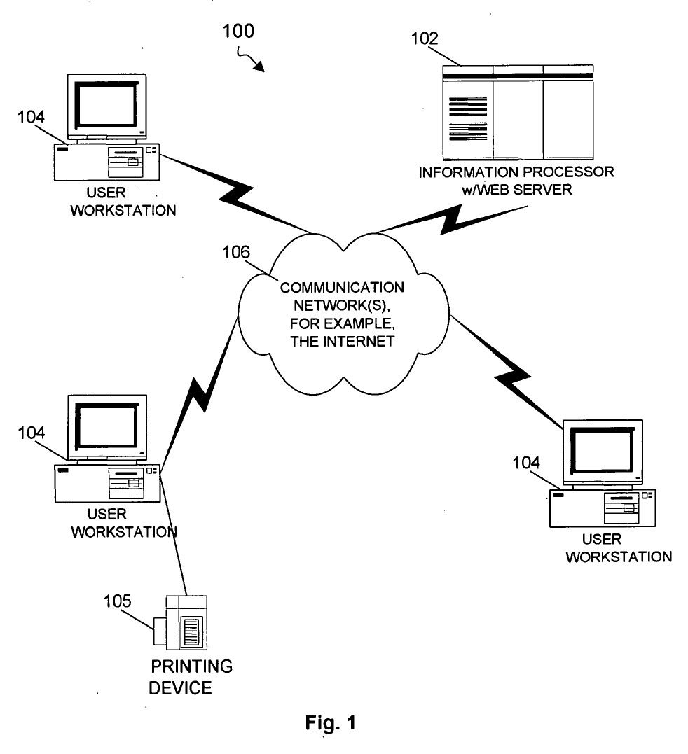

Referring now to the drawings, in which like reference numerals refer to like elements, FIG. 1 shows an example hardware arrangement in an embodiment and referred to generally as Apparel and Textile Insurance system 100. In the embodiment shown in FIG. 1, Apparel and Textile Insurance system 100 comprises at least one information processor 102 (configured to operate as an Internet web server and database file server) adapted to access communication network 106 and communicate with user workstations 104. Printing device 105 is operable to print information related to policies, items and/or claims and may formatted as any known printing device, including laser printer, ink jet printer, impact printer (e.g., dot matrix) or the like. User workstation(s) 104 and information processor(s) 102 may communicate via the known communications protocol, Transmission Control Protocol/Internet Protocol “TCP/IP.” In this way, content can be transmitted to and from the devices 102 and 104, and commands can be executed to enable the various functions described herein.

As used herein, the term, “module” refers, generally, to one or more discrete components that contribute to the effectiveness of the teachings herein. Modules can operate or, alternatively, depend upon one or more other modules in order to function.

As used herein, apparel and/or textile items refers, generally to items that include one or more of fabric, leather, fur, plastic and other natural or synthetic compositions, including upholstery. Examples of apparel and/or textile items include, but are not limited to, gowns, suits, scarves and/or other items of clothing, drapes, couches, coats, rugs, chairs, handbags, shoes, accessories, furniture and other home furnishings. Other materials, such as glass, metals, alloys or the like may be included apparel and/or textile items in accordance with the teachings herein.

Information processor 102 and user workstation 104 are any devices that are capable of sending and receiving data across communication network 106, e.g., mainframe computers, mini computers, personal computers, laptop computers, a personal digital assistants (PDA) and Internet access devices such as Web TV. In addition, information processor 102 and user workstation 104 may be equipped with a web browser, such as MICROSOFT INTERNET EXPLORER, NETSCAPE NAVIGATOR, MOZILLA FIRREFOX or the like. Thus, as envisioned herein, information processor 102 and/or user workstation 104 are devices that can communicate over a network and can be operated anywhere, including, for example, moving vehicles.

The nature of the teachings herein is such that one skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA server pages, servlets, AJAX, and/or a plurality web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. One or more data formatting and/or normalization routines may be provided that manage data received from one or a plurality of sources. In another example, data are received that are provided in a particular format (e.g., MICROSOFT EXCEL), and programming routines are executed that convert the data to another formatted (e.g., ASCII comma-delimited text or XML).

It is contemplated herein that any suitable operating system can be used on user workstations 104 and information processor 102, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, MAC OS, UNIX, LINUX, PALM OS, POCKET PC or any other suitable operating system. Of course, one skilled in the art will recognize that other software applications are available in accordance with the teachings herein, including, for example, via JAVA, JAVA Script, Action Script, Swish, or the like.

Moreover, a plurality of data file types is envisioned herein. For example, various suitable multi-media file types are supported, including (but not limited to) JPEG, BMP, GIF, TIFF, MPEG, AVI, SWF, RAW or the like (as known to those skilled in the art).

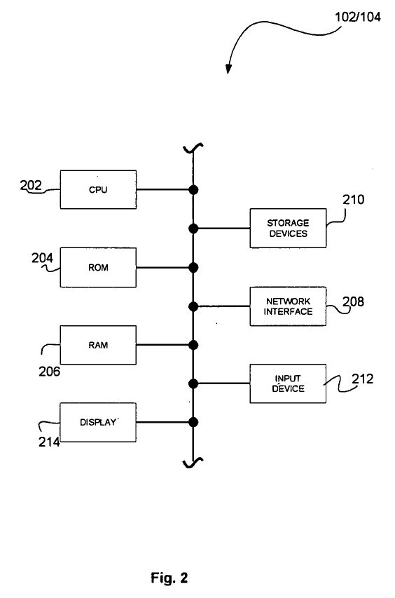

FIG. 2 illustrates the functional elements of user workstation 104 and/or information processor 102 and that include one or more central processing units (CPU) 202 used to execute software code and control the operation of computing devices 102/104, read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code, databases and application data, one or more input devices 212 such as a keyboard, mouse, track ball, microphone and the like, and a display 214.

The various components of information processor 102 and/or user workstation 104 need not be physically contained within the same chassis or even located in a single location. For example, storage device 210 may be located at a site which is remote from the remaining elements of information processor 102 or user workstation 104, and may even be connected to CPU 202 across communication network 106 via network interface 208. Information processor 102 includes a memory equipped with sufficient storage to provide the necessary databases, forums, and other community services as well as acting as a web server for communicating hypertext markup language (HTML), FLASH, Action Script, Java, Active Server Pages, Active-X control and other programs on user workstation 104. Information processor 102 are arranged with components, for example, those shown in FIG. 2, suitable for the expected operating environment of information processor 102. The CPU(s) 202, network interface(s) 208 and memory and storage devices are selected to ensure that capacities are arranged to accommodate expected demand.

In an embodiment, a system and method are provided that enable interactive exchange of information between users, such as via an Internet web site provided on information processor 102. The web site may prompt users to enter, review and/or modify information related to apparel and/or textile items, and insurance protection therefor.

In an embodiment, an apparel and/or textile item is evaluated prior to an insurance policy being issued thereon. In an embodiment, one or more data entry display screens are provided by information processor 102 and accessible to user workstations 104, such as over the Internet, for users to submit information representing the apparel and/or textile item. Information representing the item, such as a description, a manufacturer registered number (“RN”), a retailer stock keeping unit (“SKU”) number, a purchase price, a description of the condition of the item is transmitted from user workstation 104 to information processor 102. In one embodiment, a sales receipt barcode is scanned and the data therefrom is used to identify the item. Other information may be transmitted as well, such as for the age of the item and the condition of the item. For example, information may be provided that describes whether the item has been used or worn, blemished, torn, altered, or otherwise has one or more defects. Other information may be provided, such as whether the item was used as a sample or rented in a retail establishment, the amount of time from when the item was manufactured until the issuance of the policy, whether the item was sold or offered for sale on consignment, whether the item was resold, such as via EBAY or the like.

Accordingly, information related to apparel and/or textile items is provided to a database accessible by information processor 102 that identifies and represents the condition of the item at the time of the policy. In one embodiment, visual data, such as a photograph and video are also taken of the item and transmitted to information processor 102 and stored in a database accessible thereto.

In one embodiment, each insurance policy for apparel and textile items is defined for the respective item that is covered by the policy, the policy having respective terms for the item that is covered thereby. Since apparel and/or textile items have varying degrees of quality, respective policies are fashioned in accordance with the teachings herein that cover the item that is insured. By submitting information regarding the condition of the item at the time of the policy, information processor 102 has an initial reference, for example, to provide policies that preserve and protect the integrity and the condition of the insured apparel or textile item prior to the occurrence of an accident.

Over time, apparel and textile items degrade naturally, such as garments that are worn and are affected by human oils, make-up, perspiration or the like, or may be simply affected by atmospheric gases and light. Moreover, even when not worn or used, apparel and/or textile items that are in storage for long periods of time or are otherwise not new also degrade. A policy for a garment, for example, that is sold when the garment is new would not necessarily apply for the same garment after the garment has been worn for several years. Accordingly, and in one embodiment, periodic evaluations of apparel and/or textile items that are insured in accordance with the teachings herein are made, and the database accessible by information processor 102 is updated with new information regarding the evaluations. For example, a person purchases an apparel insurance policy for a new garment at the time of purchase that has a one year term. Prior to the expiration of the policy, the person has the garment evaluated for an updated condition. The new information provided to information processor 102 is used for a new policy that accurately represents the condition of the garment at the time of the new policy. In this way, accurate and subjective information can be provided to information processor 102 for a given apparel and/or textile item.

In an embodiment, a reimbursement policy is provided in the unusual circumstance that an insured item cannot be restored to its pre-accident state or, in case some promise made by the insurer with regard to the insured item cannot be kept. The reimbursement policy may identify a time period that lapsed since the policy for the item was purchased, and provides a relative reimbursement amount as a function of that time period. For example, the percentage of reimbursement for an insured item having an insurance policy that was purchased within the last six months is 100%. The percentage of reimbursement for an insured item having an insurance policy that was purchased between six months and one year may be 80%. The percentage of reimbursement for an insured item having an insurance policy that was purchased between 12 months and 18 months may be 60% of the insured value. Of course, one skilled in the art will recognize that other reimbursement percentages and time frames can be defined that represent an amount of reimbursement for an item. Moreover, percentages may be defined in accordance with updated information provided to information processor 102 as an apparel and/or textile item is evaluated over time.

Accordingly, a sliding percentage reimbursement value is provided in an embodiment that is based on an item as it was originally insured and that evolves to represent the condition and value of the item over time.

Moreover, the insurance policies may be sold by various parties. In one embodiment, retailers sell policies along with apparel and/or textile items sold in the retailers' ordinary course of business. In another embodiment, an insurer sells the policies directly to consumers and, for example, within a fixed period of time from the time of purchase of the apparel or textile item. In this embodiment, the party purchasing the policy may need to provide a declaration, affidavit or other testimony that verifies the condition of the apparel and/or textile item.

In one or more embodiments, the insurance policies include various restrictions, such as requiring that the policy is purchased at the time or shortly within the time when the insured apparel or textile item is bought. Another restriction may include that the policy covers only one, single cleaning service over the life of the policy. Yet another restriction may be that claims must be submitted within a fixed period of time, such as within one year from the date of purchase. Still another restriction may be that claims must be submitted within a fixed period of time from an accident or other event.

Moreover, the insurance policies according to an embodiment is restricted to only allow claims for accidental damage to apparel or textiles, and to deny claims for recovery from irreversible damage. Allowable claims include, for example, recovery from accidents that result in soils and dirt (e.g., spills or dropped items), and that can be treated by a professional cleaning service. It is an object and benefit of the insurance policies described herein to preserve and protect the integrity and the condition of the insured apparel or textile item prior to the occurrence of the accident.

Unlike prior art insurance claims in which individuals attempt to recover for damaged apparel or textile items under residential home or other insurance policies, the insurance policies provided in accordance with the teachings herein are purposely limited in coverage for apparel or textile items. By providing dedicated insurance policies for apparel and/or textile items according with the teachings herein, expensive insurance premium increases and deductibles under homeowner or other insurance policies are avoided via small or individual claims on pieces of apparel or interior textile items.

It is envisioned herein that some individual policy owners may be inclined to bring numerous and potentially abusive or unnecessary claims under the insurance policies described herein. For example, policyholders may bring claims for relatively minor blemishes or for otherwise perceived imperfections that do not warrant professional treatment. Alternatively, policy owners may try to submit claims for non-accidental damage, or for irreversible damage. In order to offset risks associated with these types of claims to insurers, the insurance policies in accordance with an embodiment include relatively high deductible charges. In this way, policy owners are far more likely to bring legitimate claims, such as by conducting a simple cost-benefit analysis that takes into consideration a relatively high deductible cost.

In order to prevent insurers of the policies from being overburdened in other ways, the apparel and textile insurance policy according to an embodiment does not cover “normal wear and tear.” For example, insurance claims for repairing or cleaning fabrics and textiles resulting from hemline dirt, normal depletion from excessive wearing, discoloration caused by perspiration, baby oil, make up or the like, are not covered by the apparel and textile item insurance policies described herein. One skilled in the art will recognize that the passage of time dramatically affects the likelihood that professional apparel cleaners will be able to successfully restore or clean fabric and/or textiles. The policies in accordance with an embodiment, therefore, deny claims for services for normal wear and tear.

Further, one skilled in the art will recognize that the passage of time impedes the likelihood that a stain or other blemish can be removed. Certain stains, particularly earth-based stains and protein-based stains (as known in the art), including blood stains, food stains or the like, are particularly difficult to treat after the passing of a short period time, such as days or even hours. Other stains, such as oil-based stains may be treatable over longer periods of time. Oxidation affects various materials and stains, and often prevents the ability to safely and effectively repair an item. Accordingly, terms may be defined for respective insurance policies that define time-frames for treating particular stains and materials.

In one embodiment, a test may be performed on the apparel and/or textile item to determine the passage of time and, accordingly, the age of a stain. For example, a spectrometer or other hardware device is operable to estimate the amount of time that a stain has been left untreated. In an embodiment, the apparel and textile item insurance policy denies claims in which an accident or other event resulting in a stain or other soiling occurred after a predetermined period of time from when a claim is submitted.

Another policy restriction in accordance with an embodiment regards the state of the apparel or textile at the time the insurance policy is purchased. In one embodiment, the insurance policy can only be purchased for new items, such as purchased within a predetermined period of time (e.g., two weeks). Moreover, a receipt or other proof of purchase is submitted by the customer prior to the apparel and textile item insurance policy being issued. In this way, an insurer is not burdened for having to care for items that were purchased and/or used long before an insurance policy was purchased. For example, insurers are not overburdened with a sample apparel item that was previously worn, such as by models, or otherwise tried on by customers and, thereafter, sold at a discounted price.

In an embodiment, an insured item is carefully examined when a claim is made to ensure that the policy covers treating the item. A comprehensive examination of the apparel or textile item is made in order to determine and specify stained matter and time-periods that the insurer may be obliged to remove under the terms of the policy. For example, a determination is made as to the cause of a stain, mark or other blemish, to confirm that the cause was accidental. In case a claim is denied due to a policy restriction, such as described herein, the customer is informed and the item is not accepted. Alternatively, when a claim is accepted, the item to be treated is photographed at the time the item is accepted and prior to any treatment occurring. Upon completion of the treatment, the item is photographed again, and the photographs are preferably stored in a database.

In an embodiment, a data entry display form is provided via information processor 102 for restoration evaluation of an apparel and/or textile item. Information such as contact information of the user accessing information processor 102 (e.g., e-mail and telephone number), the value of the claim, and item information is provided by the user. For example, the user submits information such as water damage, smoke damage, fire damage, dye bleeding, charred or other information relating to the damage to the apparel and/or textile item. Color information may include, for example, whether the item is solid colored, multi-colored, patterned or other. Other information that may be submitted via information processor 102 includes the date of the damage, the composition of the apparel/textile item, the cost per unit of fabric, whether the fabric is currently available, when and where the damaged items were initially purchased (e.g., from a retail establishment, an interior designer or interior design firm). Other information that may be provided via information processor 102 includes whether the item is part of an ensemble, and, if so, the condition of the complete set, whether there were preexisting imperfections (e.g. tears, rips, missing tassels, chips in buttons or the like). Other information that may be provided via information processor 102 includes whether previous restoration attempts have been made and when, what processes were used (e.g., dry cleaning, wet cleaning, ozone, or other), what solutions were used (e.g., wet side protein/base, wet side tannin/acid, bleaches or other). Further, any chemical reactions may be provided. Moreover, the user may identify certain outcome information, such as whether the customer (or the provider) was satisfied with the results, whether the problem was worsened or could not be corrected, and whether the piece is believed to be salvageable. Thus, various forms of information can be submitted in connection with a claim.

Other measures are preferably taken to protect the insurer from being overburdened by claims that directly or indirectly relate to the insurance policies according to the teachings herein. For example, policy owners are preferably provided with written disclaimers that include one or more stipulations. For example, one stipulation may be that the insurer accepts no legal responsibility in case a garment, apparel or textile is submitted with irreversible damage, such as a rip or pull in fabric, missing embellishments, discoloration due to perspiration or perfume, or was otherwise damaged that was caused by another resource during a prior cleaning, or the like. Another stipulation may be that an insurance policy in accordance with the teachings herein is non-transferable and cannot be assigned to a third party. In an embodiment, and as noted above, items with preexisting conditions are photographed and properly documented. In this way, insurers will not be held responsible for preexisting conditions, and can provide supporting evidence to customers, accordingly.

In accordance with embodiments, systems and methods are provided for textile analysis and custom care labeling to provide a safeguard for the integrity of all fabrics used in apparel, accessory or home furnishings. The teachings herein are particularly helpful for unconventional cleaning processing or other special attention that may be required for cleaning and finishing apparel, accessories or home furnishings. In an embodiment, a custom care label is provided to give specific care instructions to safeguard garments. In particular, detailed instructions, including very intricate details for treatment, are included. Further, various textiles including swatches to finished garments are tested to determine the best method for cleaning and preserving a particular garment. Customized estimates are prepared in advance of any work. Furthermore, the program benefits cleaners by reducing liability and maximizing the longevity and integrity of collections.

The teachings herein operate to safeguard the integrity of all fabrics used in apparel, accessory or home furnishings. Moreover, the systems and methods herein eliminate guesswork associated with the diligent care of intricate fabrics.

A custom care label program is provided to cover an individual's unique textile collection(s). By providing a new and innovative custom care label, service information is provided in detail to assist parties with the correct care instructions for each and every piece in parties' collections. This program covers even the most intricate details, such as complex pleating, “painted” trims, metallic embroidery, delicate beading, or the like.

In an embodiment, details of a custom care label program are stored in one or more databases accessible by information processor 102.

Moreover, the teachings herein provide for testing of textile items in order to ensure that proper care handling instructions and identifications are followed. For example, fabric swatches representing particular textiles or finished garments are tested in order to determine a suitable or optimum method of cleaning. In this way, parties are able to maintain dimensional stability, color fastness and overall garment appearance after dictating the correct cleaning process. For optimal results, all trims, embroideries and embellishments should undergo the testing process to ensure their durability during the determined cleaning method.

Testing for various types of textile items, apparel and interior home furnishings may occur in various ways. For example, an individual swatch of fabric to be sold may be tested by a visual inspection to determine that the fabric was made without any defects. Alternatively or in addition, a physical inspection may be made to determine that the construction of the fabric can withstand a predetermined amount of mechanical action. Further, a fabric composition test may be conducted to determine safe cleaning methods and materials. In one embodiment, a black light inspection may be conducted to determine whether, for example, optical brighteners were used. Moreover, black light inspection may be combined with the other tests described herein, prior to performing any physical cleaning on the item.

Moreover, a fabric swatch may also be tested via several different methods of cleaning and several times in order to properly identify and dictate appropriate methods and cleansers that can be safely used and that will preserve the integrity of the fabric swatch. Moreover, a determination may be made whether any cleaning agent is inappropriate for a particular fabric. Outcomes of the determination are noted. For example, moisture should not be applied to acetate velvet, as moisture will crush the velvet piles and cause irreversible damage. Accordingly, various cleaning agents may be tested to define what can and cannot be used in a “spotting” or stain removal process.

Additionally, there may be other applications for different fabrics that are required in the cleaning and/or rinsing of a fabric. For example, some forms of waterproofing may decay and come off, once cleaned and would, accordingly, require a reapplication using one or more specific techniques. Additionally, a plurality of variously sized swatches may be tested, some swatches multiple times, in order to test the “feel” and “handle” of the fabric. Accordingly, test(s) for a particular fabric swatch may be performed for testing the finishing of the fabric. For example, after cleaning any fabric, proper finishing techniques may be required in order to restore the fabric's composition to its original look and feel. Moreover, some fabrics are heat sensitive and use of a conventional steam iron can distort and destroy pleating, finished appearances or the like.

Certain items are constructed in ways that integrate textiles. For example, drapes may be provided with tassels. In another example, a piece of furniture may be provided with various textile materials. Such items may require that each piece that is part of the construction of the total embodying item undergoes testing, such as described above, in order to properly dictate proper care for the item. Moreover, various techniques for testing may be applied for preservation of materials. For example, a silk suit that is provided with glass buttons must be modified so that the buttons are removed prior to performing any testing on the suit. In other examples, hand painted items on silk satin fabric are tested independently. In another example, a combined leather and fabric construction are tested separately to determine what process and/or cleaning materials are safe for both. Thus, a plurality different of compositions, from fabrics, metals, natural and synthetic materials in a single item, are all tested to determine whether parts of the item require separate cleaning methods and cleansers, or whether the item as whole can be treated in a single process with the same cleansing material. For example, a particular solvent may be useful for a single item, notwithstanding the item containing a plurality of materials.

In an embodiment, a written report is provided for customers that identifies testing results for apparel and/or textile item. Textile analysis and care label professionals research, design, dictate, source and oversee the production of all custom care labels, in order to ensure that instructions and care techniques are followed ranging from the most basic to very unconventional care techniques.

Moreover, estimates may be made in connection with caring for apparel and/or textile items and are prepared in advance of any work. A textile analysis price structure may be developed and based upon a number of times as well as the quantity of different types of cleaning methods that are to be employed in a testing process in order to determine correct care instructions. For example, care instructions include a number and complexity of textiles and trims.

Customized care labels in accordance with the teachings herein provide various advantages over typical prior art systems. For example, labels reduce liability by preventing errors that may result in returns and unhappy customers. Further, proper labeling also maximizes the longevity and integrity of textiles collections and pieces. This enables providers to meet quality expectations of providers' clientele. Moreover, a manufacturer may be held liable for an apparel or textile item as a function of proper procedures being followed in accordance with a custom care label.

Accordingly, the textile analysis and care labeling system and method in connection with the teachings herein improve the ability for a provider to appraise the relative quality of textiles and their corresponding functionality. Further, using the teachings herein, providers are aware of particularly fragile or otherwise delicate textiles, and can help customers to avoid having professionals in the dry cleaning industry “blacklist” or otherwise refuse care for particular textiles.

The teachings herein improve customer satisfaction and, correspondingly, boost companies sales volumes and improve public image. Items that were otherwise considered “unserviceable” due to lack of correct care techniques are now improved, thereby improving the availability of services to providers' clients.

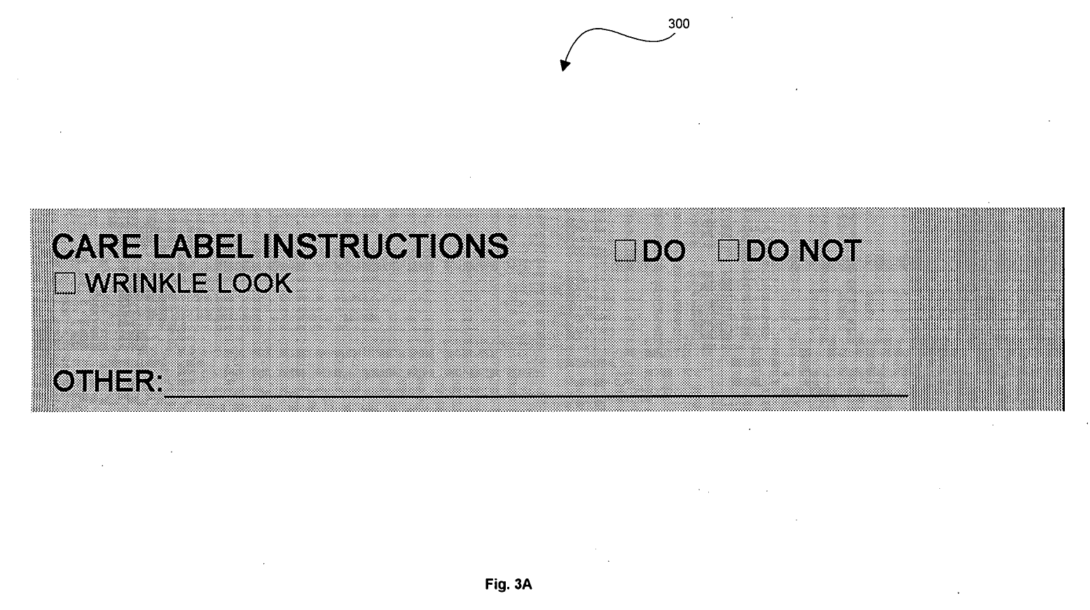

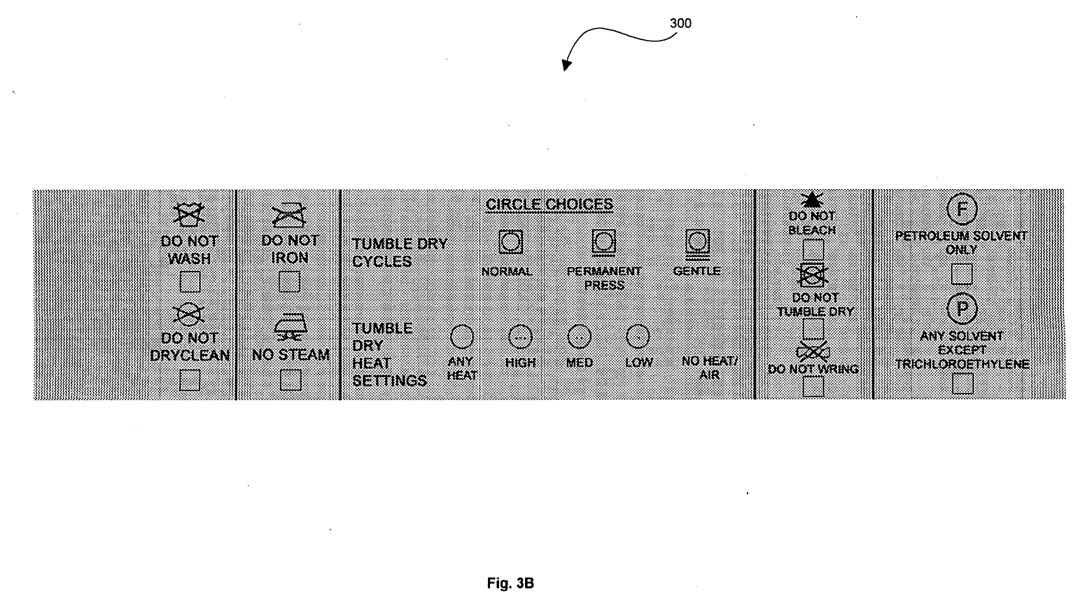

FIGS. 3A and 3B illustrate a custom care label 302 provided in connection with the teachings herein. As shown in FIGS. 3A and 3B, detailed instructions, beyond typical prior art instructions directing “Dry Clean Only,” are provided. In an embodiment, various options are provided with the label that include checkboxes or areas to be circled in order to quickly and easily impart correct care instructions for respective textiles. In the example shown in FIG. 3A, the user is directed not to wash, iron or dry-clean the textile. The user is further directed not to tumble dry the item, and not to wring the item.

Continuing with the example care label 302 shown in FIG. 3A, various other options are available for identifying particular instructions in connection with textile treatment. For example, tumble dry setting options, relative heat settings and types of acceptable solvents are identified for a user who will care for a textile. Further, space may be provided for custom care instructions that enable a user to write directly on the label. In the example shown in FIG. 3A, checkboxes are provided for a user to instruct whether the custom written instructions are to be followed or avoided (e.g., “DO NOT” or “DO”).

Thus, and as shown in the example care label 302 in FIGS. 3A and 3B, a convenient, accurate and useful custom care label is provided that assists in the care of apparel and/or textile items. By incorporating both checkboxes and custom written text, users can ensure that accurate instructions can be quickly and easily imparted to cleaners and other providers of textile care.

In an embodiment, certain handling requirements are imposed on apparel and/or textile items in order for a claim to be accepted. In one embodiment, requirements directed by care label 302, such as shown in FIGS. 3A and 3B, define acceptable treatment instructions that must be followed for a claim to be accepted. In an embodiment, after an apparel and/or textile item is treated in accordance with specific requirements, such as provided via care label 302, a user transmits information to information processor 102 to certify compliance with care label 302 instructions.

Moreover, in case a claim is denied (or partially denied), such as due to normal wear and tear damage and not covered by the policy, the insurer may offer discount rates to the policy owner for additional services. For example, the insurer may offer to restore the apparel or textile item not covered by the insurance policy at a substantially reduced rate. This practice promotes good customer relations and can result in future customer referrals, additional work or other benefits to the insurer. In the event that the insured patron declines to accept the insurer's offer to provide cleaning or other services (either at regular or discounted rates), then the apparel or textile item is returned to the insured. Alternatively, if a claim is partially denied, then the insured is preferably provided with a written and/or oral disclaimer that the insurer will not guarantee the item and will, therefore, not be held responsible for the portion of the apparel or item that is not covered by the policy.

In one preferred embodiment, the insurance policy provided in accordance with the teachings herein covers a fixed amount of time, such as three years. During the fixed period of time, the insured item is preferably covered for unanticipated accidents, resulting in dirt and spills that require cleaning. As noted above, in one embodiment, the policy is sold in a retail establishment that sells the items to be insured. In an alternative embodiment, the policy is purchased directly from the insurer. In a preferred embodiment, insurance policies will cover the value of the apparel or textile item, minus any cost of depreciation of the apparel or item over time.

The insurance policy according to the teachings herein may require that each insured item has a minimum value. For example, textile items (e.g., couches, drapes or the like) may be insurable provided that the minimum value of the textile item is a certain amount, such as $5,000. In this way, quality items are eligible for insurance. Further, the cost of individual insurance policies are preferably based either directly or indirectly on the purchase price or assessed value of the item being insured. For example, an insurance policy may cost 10% of the purchase price (or assessed value) of an item being insured. In this example, a $3,000 gown costs $300 to insure. As noted above, the party purchasing the insurance policy preferably submits a receipt or other evidence showing the value of the item to be insured. In case a claim is brought by the insured, an insurance claim assessment form is preferably completed by the insurer that identifies the value of the item and also ensures that other information required for satisfying the claim is properly submitted at the time of purchase.

Accordingly, it is envisioned that various markets would benefit from the teachings herein. For example, designers of clothing, apparel and textile products offer the insurance policy described herein as an incentive to buyers. Additionally and as noted above, retail establishments that sell, rent or lease clothing, apparel and/or textile items offer the insurance policy described herein as an incentive. Other possible policy sellers include restaurants, hotels, interior designers and decorators.

Although the present invention is described and shown in relation to particular embodiments thereof, many other variations and modifications and other uses will become apparent to those skilled in the art. It is preferred, therefore, that the present invention be limited not by the specific disclosure herein.

What is claimed is:

1. A method for a processor managing an apparel and textile item insurance policy, the method comprising:
storing, on one or more processor readable media that are operatively coupled to one or more processors, at least one database including:
electronic apparel information including information representing at least one apparel or textile item;
electronic policy information including information representing at least one insurance policy respectively associated with the at least one apparel or textile item;
receiving, via a communication device, that is operatively connected to the one or more processors, first electronic apparel information, from a first user computing device operated by a first user, that represents an apparel or textile item;
retrieving from the at least one database by the one or more processors, electronic policy information representing a policy relating to the apparel or the textile item, and electronically assigning by the one or more processors the policy to the apparel or textile item;
receiving, via the communication device, electronic claim information from the first computing device or a second user computing device, wherein the electronic claim information represents a claim on the policy for the apparel or textile item;
determining, by the one or more processors, whether the policy for the apparel or textile item covers the claim; and
transmitting by the one or more processors either:
an electronic authorization notification for the claim if the one or more processors determines that the policy covers the claim; or
a electronic denial notification for the claim if the one or more processors determines that the policy does not cover the claim.

2. The method of claim 1, wherein the policy covers cleaning services for accidental soiling of the apparel or textile item.

3. The method of claim 2, wherein the policy requires that the apparel or textile item be cleaned within a predetermined amount of time of the accidental soiling.

4. The method of claim 1, wherein the policy requires that the apparel or textile item be maintained according to at least one predetermined rule.

5. The method of claim 4, further comprising storing in the at least one database the at least one predetermined rule.

6. The method of claim 4, further comprising receiving by the one or more processors an electronic certification from the first computing device or a second computing device that the apparel or textile item was maintained according to the at least one predetermined rule.

7. The method of claim 4, wherein the at least one predetermined rule is specified on a custom care label.

8. The method of claim 1, wherein the policy further covers at least partial replacement value of the apparel or textile item if the apparel item or textile item cannot be cleaned.

9. The method of claim 1, wherein the electronic apparel information includes at least one selected from a group consisting of a description, a manufacturer RN number, a retailer SKU number, a purchase price, a description of item's condition and the item's age of the item.

10. The method of claim 1, further comprising storing in the at least one database at least one photograph of the apparel or textile item.

11. A computer program product, comprising a computer usable medium having computer readable program code embodied therein, the computer readable program code configured to implement a method for a processor managing an apparel and textile item insurance policy, the method comprising:
storing, on one or more processor readable media that are operatively coupled to one or more processors, at least one database including:
electronic apparel information including information representing at least one apparel or textile item;
electronic policy information including information representing at least one insurance policy respectively associated with the at least one apparel or textile item;
receiving, via a communication device, that is operatively connected to the one or more processors, first electronic apparel information, from a first user computing device operated by a first user, that represents an apparel or textile item;
retrieving from the at least one database by the one or more processors, electronic policy information representing a policy relating to the apparel or the textile item, and electronically assigning by the one or more processors the policy to the apparel or textile item;
receiving, via the communication device, electronic claim information from the first computing device or a second user computing device, wherein the electronic claim information represents a claim on the policy for the apparel or textile item;
determining, by the one or more processors, whether the policy for the apparel or textile item covers the claim; and
transmitting by the one or more processors:
an electronic authorization notification for the claim if the one or more processors determines that the policy covers the claim; or
a electronic denial notification for the claim if the one or more processors determines that the policy does not cover the claim.

12. The computer program product of claim 11, wherein the policy covers cleaning services for accidental soiling of the apparel or textile item.

13. The computer program product of claim 12, wherein the policy requires that the apparel or textile item be cleaned within a predetermined amount of time of the accidental soiling.

14. The computer program product of claim 11, wherein the policy requires that the apparel or textile item be maintained according to at least one predetermined rule.

15. The computer program product of claim 14, wherein the method further comprises storing in the at least one database the at least one predetermined rule.

16. The computer program product of claim 14, wherein the method further comprises receiving by the one or more processors an electronic certification from the first computing device or a second computing device that the apparel or textile item was maintained according to the at least one predetermined rule.

17. The computer program product of claim 14, wherein the at least one predetermined rule is specified on a custom care label.

18. The computer program product of claim 11, wherein the policy further covers at least partial replacement value of the apparel or textile item if the apparel item or textile item cannot be cleaned.

19. The method computer program product of claim 11, wherein the electronic apparel information includes at least one selected from a group consisting of a description, a manufacturer RN number, a retailer SKU number, a purchase price, a description of item's condition and the item's age of the item.

20. A custom care label program provided by at least one processor, the program comprising:
at least one database stored on one or more processor readable media that are operatively coupled to the at least one processor, the at least one database including:
test results from testing apparel and textile items; and
respective instructions for correct care for the apparel and textile items, wherein the instructions are provided as a function of the test results;
and a care label that graphically represents the respective instructions for at least one of the apparel and textile items, wherein the care label is provided with the at least one of the apparel and textile items.
